(19) United States
(12) Patent Application Publication
(10) Pub. No.: US 2017/0265488 A1
(43) Pub. Date: Sep. 21, 2017

(54) Chitterling Cleaner

(71) Applicant: Clara Washington, Florissant, MO (US)

(72) Inventor: Clara Washington, Florissant, MO (US)

(21) Appl. No.: 15/465,009

(22) Filed: Mar. 21, 2017

Related U.S. Application Data
(60) Provisional application No. 62/390,175, filed on Mar. 21, 2016.

(51) Int. Cl. A22C 17/16

(52) U.S. Cl. CPC A22C 17/16

(57) ABSTRACT

A chitterling cleaner. The chitterling cleaner includes a knife having a curved handle section and a body extending therefrom. A lower edge of the body has a track thereon. A blade having a slot for receiving the track is removably securable to the body via a friction fit. In one embodiment, the blade includes a plurality of serrated teeth thereon. The slot and track can be composed of magnetic materials to ensure a strong connection when the blade is secured to the knife body. The chitterling cleaner is used to scrape unwanted particles and debris from a chitterling prior to cooking.

### CROSS REFERENCE TO RELATED APPLICATIONS

This application claims the benefit of U.S. Provisional Application No. 62/390,175 filed on Mar. 21, 2016. The above identified patent application is herein incorporated by reference in its entirety to provide continuity of disclosure.

### FIELD OF THE INVENTION

The present invention relates to knives. More specifically, the present invention provides a chitterling cleaner including a knife with a removably attached blade.

### BACKGROUND OF THE INVENTION

Chitterlings are a prepared food made from the small intestine of a pig. In order to properly prepare chitterlings, they must first be cleaned and rinsed several times to remove debris and any tough parts on the surface. It can be difficult and time consuming to effectively clean the chitterlings prior to cooking. Typically knives are not suited for the task and can end up damaging the chitterlings. It is therefore desirable to provide a chitterling cleaner having a removably securable blade.

### SUMMARY OF THE INVENTION

In view of the foregoing disadvantages inherent in the known types of chitterling cleaning devices now present in the prior art, the present invention provides a chitterling cleaner wherein the same can be utilized for providing convenience for the user when cleaning chitterlings prior to cooking. The chitterling cleaner includes a knife having a curved handle and a body extending therefrom. A track is disposed on a lower edge of the body, the track comprising a rectangular projection extending from a first end of the body to a second end of the body. A blade having a slot thereon is configured to receive the track, such that the blade is removably secured to the body via frictional engagement therewith.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded perspective view of the chitterling cleaner.

### DETAILED DESCRIPTION OF THE INVENTION

Reference is made herein to the attached drawings. Like reference numerals are used throughout the drawings to depict like or similar elements of the chitterling cleaner. For the purposes of presenting a brief and clear description of the present invention, the preferred embodiment will be discussed as used for cleaning chitterlings prior to cooking. The figures are intended for representative purposes only and should not be considered to be limiting in any respect.

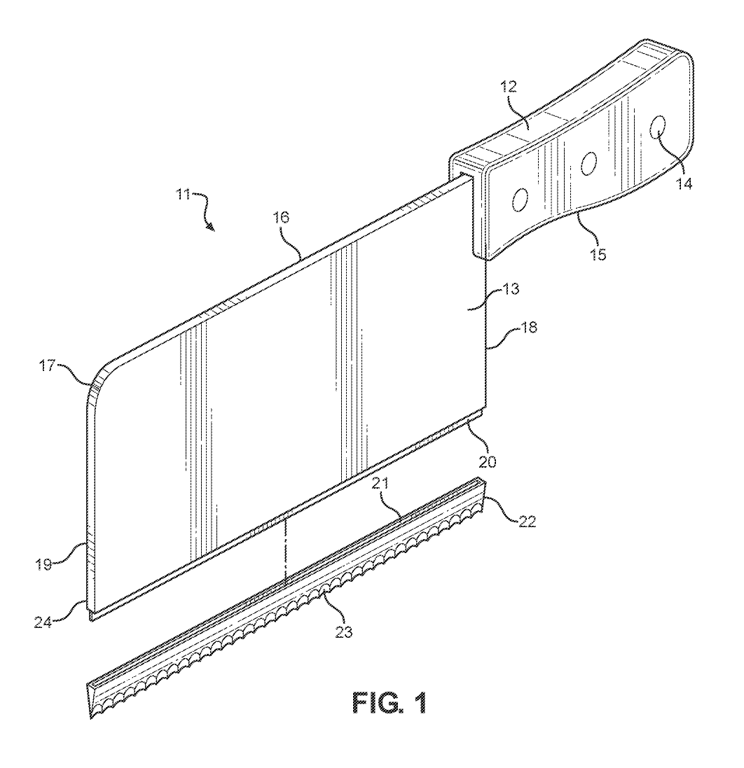

Referring now to FIG. 1, there is shown an exploded perspective view of the chitterling cleaner. The chitterling cleaner 11 generally comprises a body 13 secured to a handle 12. The body 13 can be secured to the handle 12 via one or more fasteners 14. The handle preferably includes a curved lower end 15 so that it may be comfortably gripped by the user.

In the illustrated embodiment, the body 13 comprises a first end 18 and a second end 19. A straight upper edge 16 extends from the first end 18 to the second end 19. The straight upper edge 16 terminates at a curved portion 17 which then extends downward to a lower end 24 of the body 13. A track 20 is disposed on the lower end 24 of the body 13. The track 20 is rectangular and extends from the first side 18 to the second side 19 of the body 13.

The blade 22 of the chitterling cleaner 11 is removably securable to the body 13. The blade includes a channel 21 extending across the length thereof. The channel 21 is sized to receive the track 20 of the body 13. The track 20 frictionally engages the channel 21 in order to secure the blade 22 to the body 13. In one embodiment, the channel 21 and track 20 are composed of magnetic materials, so that the connection between the blade 22 and the body 13 is sufficiently secure so as not to fail during use. When not in use, the blade 22 can be separated from the body 13 for storage or cleaning purposes.

In the illustrated embodiment, the blade 22 comprises a plurality of teeth 23 thereon. In alternate embodiments, the blade 22 comprises a smooth lower edge. The teeth 23 can also be angled, or may extend downward as shown in the illustrated embodiment. In use, the handle 12 is gripped by the user, while a portion of the user's fingers also grip the body 13. The blade 22 is then scraped back and forth across the chitterling, which effectively cleans the chitterling prior to cooking.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A chitterling cleaner, comprising:
a knife having a handle and a body extending therefrom;
a track disposed on a lower edge of the body, the track comprising a rectangular projection extending from a first end of the body to a second end of the body;
a blade having a slot thereon, the slot configured to receive the track;
wherein the blade is removably secured to the body via frictional engagement therewith.

2) The chitterling cleaner of claim 1, wherein the handle includes a curved lower end.

3) The chitterling cleaner of claim 1, wherein the handle is secured to the body via one or more fasteners.

4) The knife of claim 1, wherein the blade includes a plurality of serrated teeth thereon.

5) The knife of claim 1, wherein the blade comprises a smooth cutting edge.

6) The knife of claim 1, wherein the track and the slot are composed of magnetic materials such that the slot of the blade is magnetically attracted to the track on the body.
